(19) United States
(12) Patent Application Publication
(10) Pub. No.: US 2005/0048278 A1
(43) Pub. Date: Mar. 3, 2005

(54) Use of flame retardants in linoleum or cork-based floor coverings

(75) Inventors: David Reichwein, Elizabethtown, PA (US); Milko Ess, Delmenhorst (DE); Guido Burmeister, Wildeshausen (DE); Karl-Heinz Schwonke, Lochgau (DE)

Correspondence Address: SUGHRUE MION, PLLC, 2100 PENNSYLVANIA AVENUE, N.W., SUITE 800, WASHINGTON, DC, 20037, US

(73) Assignee: ARMSTRONG DLW AG

(21) Appl. No.: 10/842,692

(22) Filed: May 11, 2004

(30) Foreign Application Priority Data
May 13, 2003 (DE) 10321479.8

(51) Int. Cl. B32B 5/16; B27N 9/00

(52) U.S. Cl. 428/331; 428/920

(57) ABSTRACT

The present invention relates to a linoleum-based floor covering with improved flame retardant properties, comprising at least one layer of linoleum, which contains at least one silicon-containing inorganic compound as a flame retardant in an amount of up to 40% by weight relative to the weight of the linoleum layer, and to a method for producing the same. The invention further relates to a cork-based floor covering with improved flame retardant properties, comprising at least one silicon-containing inorganic compound as a flame retardant in an amount of up to 40% by weight relative to the amount of the cork layer.

### FIELD AND BACKGROUND OF THE INVENTION

The present invention relates to a linoleum-based floor covering with improved flame-retardant properties, comprising at least one linoleum layer that contains at least one silicon-containing inorganic compound as a flame retardant in an amount of up to 40% by weight relative to the weight of the linoleum layer and a method for producing the same. The present invention further relates to a cork-based floor covering with improved flame-retardant properties, comprising at least one silicon-containing inorganic compound as a flame retardant in an amount of up to 40% by weight relative to the weight of the cork layer.

Linoleum-based floor coverings and methods for their production have been known for a long time. However, a drawback of the linoleum-based floor coverings of the prior art is their critical fire behavior (fire test in accordance with DIN 4102 T14, “Radiant Flooring Panel Test”). Since June 2002, the requirements to be met by flooring have been further tightened by a new EN Standard. Whereas linoleum flooring previously had to reach a so-called critical radiation intensity of ≧4.5 kW/m² in accordance with DIN 4102 T14 to be classified in the economically important Building Materials Class B1, floor coverings, particularly linoleum, with a test result of >4.5 kW/m² are no longer classified as B1 but as C_{fl} following the introduction of the new test method in accordance with EN ISO 9239-1 and EN ISO 11925-2, which, although based on the old test DIN 4102 T14 is now classified in accordance with DIN EN 13501-1. This can cause significant competitive disadvantages compared to other synthetic flooring, e.g., PVC. Only when a critical radiation intensity of ≧8 kW/m² is reached is a classification in the economically important Building Materials Class B_{fl} possible. The critical fire behavior is also a drawback in cork-based flooring of the prior art.

### OBJECTS OF THE INVENTION

Thus, the object of the present invention is to provide a linoleum-based or cork-based floor covering with clearly improved fire behavior but otherwise substantially unchanged material characteristics compared to the linoleum or cork-based floor coverings known in the prior art.

### SUMMARY OF THE INVENTION

This object is attained by the items set forth in the claims.

In particular, a linoleum-based floor covering is provided, which has at least one linoleum layer that contains at least one silicon-containing inorganic compound as a flame retardant in an amount of up to approximately 40% by weight, preferably in an amount ranging from 0.2 to 30% by weight, more preferably ranging from 2 to 18% by weight relative to the weight of the linoleum layer.

In a preferred embodiment of the present invention, perlite is used as the silicon-containing inorganic compound. The perlite used according to the invention can be expanded or unexpanded.

The use of perlite, preferably heat-treated perlite (“pearlstone,” a natural volcanic rock, which is briefly heated to a temperature greater than 1000° C., such that the water contained in the stone expands the perlite to 20 times its original volume, also referred to as “puff perlite”) improves the fire behavior of a linoleum-based floor covering and reaches a critical radiation intensity value of >8 kW/m² in the B_{fl} test. Furthermore, perlites are usually almost colorless. As a result, when used as a component in the floor covering according to the invention, they do not influence the appearance of the e.g., linoleum-based flooring, which is an advantage over the use of, e.g., expanded graphite as a flame-retardant (cf. WO 02/081812).

In the floor covering according to the invention, the conventionally used wood flour filler (organic, flammable), e.g., can be replaced with perlite, preferably heat-treated perlite (inorganic, non-flammable). If wood flour is replaced with other inorganic fillers (chalk, ATH), the Flammability Class B_{fl} cannot be reached within the narrow formulation limits required to still allow processing. According to the invention, however, it was surprisingly found that the Flammability Class B_{fl} could be reached with perlite, preferably heat-treated perlite.

With the use of perlite, preferably heat-treated perlite, the cement component in the formulation for the linoleum layer must be reduced because perlite does not absorb the liquid components in the cement as well as, for example, wood flour. As a result, the formulation becomes even more inorganic than it already is because of the use of perlite. Perlite, preferably heat-treated perlite, is cheaper than, for example, phosphorus compounds, which also come into consideration as flame-retardants. In addition, the dimensional stability of the linoleum floor covering according to the invention increases as a result of the lower filler ratio, e.g., wood flour, and the reduced moisture sensitivity. At the same time, the use of perlite, which typically has a finer structure, imparts a smoother surface than other fillers known in the art, e.g., wood flour, which usually has a coarser structure. Furthermore, the use of perlite according to the invention, preferably heat-treated perlite, results in a harder surface, which has a favorable effect on the abrasion and cleaning (staining) behavior of the floor covering according to the invention.

Other flame-retardants, which can be used in the linoleum layer in addition, are not subject to any special limitations. For example, it is possible to use the flame retardants conventional in the art selected from the group of the char-forming and fire-blanketing flame retardants, such as ammonium phosphate or dipentaerythritol, the barrier-forming flame retardants, such as water glass, borates and ammonium polyphosphates, the solid inorganic flame retardants and the insulating layer-forming flame retardants or intumescent agents. Other flame retardants that can be used in addition are inorganic or organic phosphorus compounds, halogenated organic compounds, such as chlorinated paraffins or halogenated organic phosphorous compounds. Solid inorganic flame retardants are, for example, inorganic compounds, such as hydrous aluminum oxides, borates, e.g., zinc borates, ammonium phosphates, antimony oxides, aluminum hydroxides, preferably aluminum trihydroxide, and magnesium hydroxide. Aluminum hydroxide and magnesium hydroxide are also known as water splitting flame retardants. The proportion of solid inorganic flame retardant is preferably up to approximately 60% by weight, particularly preferably up to approximately 30% by weight based on the weight of the linoleum layer. The solid inorganic flame retardant aluminum trihydroxide is particularly preferred. These flame retardants can be present in the linoleum layer either alone or in the form of a mixture of at least two of these flame retardants (from the same or from different groups listed above).

In a preferred embodiment, at least one phosphorous-containing flame retardant is used in addition to perlite. The phosphorus-containing flame retardant includes at least one phosphorus-containing compound. Examples of phosphorous-containing compounds are preferably selected from the group of phosphate, phosphite, phosphonate or its salts, organically substituted phosphonate or its salts, phosphinate or its salts, organically substituted phosphinate or its salts, and mixtures thereof. Examples of organically substituted phosphonates are cyclic or acyclic esters of organic phosphoric acids, such as diesters, e.g., dimethyl propanephosphonate. Particularly preferred is the use of at least one phosphinate in addition to perlite. The phosphorous-containing flame retardant can be used in an amount of, e.g., up to approximately 20% by weight, preferably in an amount ranging from 0.1 to 10% by weight, more preferably ranging from 0.1 to 6% by weight, relative to the weight of the linoleum layer.

If water glass is incorporated in addition, the processing properties can be clearly improved (i.e., an “inner structure” is formed in the mass to stiffen it) and the curing time can be substantially reduced. The water glass which can be used and which is a barrier forming flame retardant is sodium silicate, for example. It is also possible to use a mixture of two different barrier-forming flame retardants in the linoleum layer, i.e., water glass in combination with one or more of the barrier-forming flame retardants described above. Water glass may be present in the linoleum layer in an amount of up to approximately 15% by weight relative to the weight of the linoleum layer.

In contrast to the conventionally held view that highly alkaline substances destroy the structure of the linoleum, it has been observed, surprisingly, that if water glass is added in proportions of up 15%, the pH value is regulated by the acids naturally present in the linoleum cement and those created during the cooking and curing process.

With the use of, for example, sodium silicate, it has furthermore been found that the water glass basically polycondenses in long chains. An “inner structure” is thereby formed within the linoleum mass, which in connection with the oxidative curing of the linoleum results in a more rapidly curing material with improved properties regarding, e.g., fire behavior, degree of hardness, flexibility, abrasion, etc. In addition, if water glass is used in combination with liquid/viscous flame retardants, the stiffening properties of water glass can be nearly cancelled out by a saponification process of the liquid/viscous fire retardant, such that the released salts act as pH buffers and the linoleum mass can be kept substantially pH neutral.

The linoleum layer further contains common components such as binders (known as Bedford cement or B cement, which is made of partially oxidized linseed oil and at least one resin as a tackifyer), at least one filler and, where applicable, a coloring agent. The fillers used are typically soft wood flour and/or cork flour (if both wood flour and cork flour are used, the weight ratio is typically 90:10) and/or chalk, kaolin (China clay), kieselguhr and heavy spar. To stiffen the mass, precipitated silicic acid and small amounts of water glass, e.g., water glass in an amount of up to 15% by weight relative to the amount of the layer, may be added in addition.

The linoleum mass typically contains at least one coloring agent, such as a pigment (e.g., titanium dioxide), and/or other common coloring agents based on inorganic and organic dyes. Any natural or synthetic dyes and inorganic or organic pigments may be used as coloring agents, either alone or in any desired combination.

A typical linoleum composition contains approximately 40% by weight of binder, approximately 30% by weight of organic substances, approximately 20% by weight of inorganic (mineral) fillers and approximately 10% by weight of coloring agents, relative to the weight of the linoleum layer. The linoleum mass can further contain conventional additives such as processing aids, antioxidants, UV stabilizers, slip additives, etc., which are selected as a function of the binder.

In addition, the linoleum-based floor covering according to the invention may also be made electrically conductive by adding at least one imidazole, imidazoline, benzimidazole or morpholine derivative or a cationic compound such as a quaternary ammonium salt, e.g., tetraalkylammonium salt (cf. DE 34 16 573 and WO 99/10592) and/or by arranging a linoleum-based layer which contains at least one electrically conductive filler, e.g., carbon black or metal powder, underneath the linoleum layer. Such an electrically conductive layer may of course also contain one or more of the aforementioned flame retardants.

The linoleum layer has a thickness of preferably 0.9 to 6.0 mm, particularly preferably 1.4 to 4 mm.

The linoleum-based floor covering according to the invention can have no backing (DE 199 10 389 A1) or can include a backing. The backing material can be based on natural or synthetic woven or knitted fabrics or textile materials. To be cited as examples are jute fabrics, mixed fabrics of natural fibers, e.g., cotton and viscose staple fibers, glass fiber fabrics, glass fiber fabrics coated with a bonding agent, mixed fabrics made of synthetic fibers, fabrics made of core/sheath fibers, e.g., with a polyester core and a polyamide sheath. A bonding agent suitable for glass fiber fabrics is, e.g., styrene-butadiene latex for coating the glass fibers.

The floor covering according to the invention may be configured with or without a backing and the linoleum layer may be a single or a multiple layer. If the linoleum layer has a multilayer configuration, the percentage of perlite and other flame retardants, such as phosphorus-containing flame retardants, can be the same or different in the respective layers and can be present, for example, in only one layer. Furthermore, depending on the layer sequence, symmetrical or asymmetrical flat structures may result. Symmetrical structures are preferred for flat linoleum structures without backing. The floor covering according to the invention can include, for example, two linoleum layers (homogenous material), which can be the same or different.

Furthermore, a corkment layer, with or without backing, can be arranged underneath the linoleum layer. Corkment is a mixture which contains B cement and ground cork as a filler and which is used in floor coverings as an insulating sublayer to improve heat insulation, elasticity and walking comfort and to dampen the sound of footfalls and room noise. Such a corkment layer may again contain one or more of the aforementioned flame retardants.

In addition, functional layers may be arranged underneath or between two linoleum layers, such that three-layer or multiple layer structures are obtained. For example, at least one additional layer, preferably a foam layer, a layer to dampen footfall noise and/or an insulating layer may be arranged underneath the linoleum layer of the floor covering according to the invention. The thicknesses of the applied layers can be the same or different. All of these functional layers, which are arranged underneath or between two linoleum layers, can again contain one or more of the aforementioned flame retardants.

Furthermore, a bonding layer may be applied to the backside of the inventive floor covering without backing.

In addition, the floor covering according to the invention can be provided with a cover layer or a varnish coating, e.g., made of acrylate or materials based on renewable raw materials, particularly a material containing a polyreaction product, including a binder that is a reaction product of at least one dicarboxylic or polycarboxylic acid or derivatives thereof, or a mixture thereof, with at least one epoxidation product and possibly a filler. The latter material is described in WO 98/28356 to which explicit reference is made. The cover layer or varnish coating may also contain one or more of the aforementioned flame retardants.

The linoleum-based floor covering according to the invention may be present in the form of strips or tiles.

The linoleum-based floor covering according to the invention can be manufactured, for example, using the usual processes for producing single or multiple layer linoleum floor coverings with or without backing. Preferably, when linoleum cements produced in accordance with DIN EN 548 from drying plant oils or fats and tree resins are processed, phosphates, phosphites, phosphonates or their salts, organically substituted phosphonates or their salts, phosphinates or their salts, organically substituted phosphinates or their salts, or mixtures thereof, are added already during the stage of the oil oxidation process to effect a reaction of the aforementioned phosphorus compounds, e.g., with free double bonds, or esterification with existing OH groups, or to achieve at least a close linking (mixing) with the linoleum cement.

The present invention further provides a common method for manufacturing a linoleum-based floor covering, including at least one layer of linoleum, which contains at least one silicon-containing inorganic compound defined above as a flame retardant in an amount of up to 40% by weight relative to the weight of the linoleum layer, wherein the linoleum mass, which contains at least one silicon-containing inorganic compound, is processed into a floor covering with or without jute backing using calenders or roll mills. According to a preferred embodiment, at least one of the aforementioned flame retardants can be used in addition, as defined above.

The present invention further provides a cork-based floor covering including at least one silicon-containing inorganic compound defined above as a flame retardant in an amount of up to approximately 40% by weight relative to the weight of the cork layer.

Flame retardants, which can be used in addition in the cork-based floor covering, are not subject to any particular limitation. It is possible, for example, to use the flame retardants conventional in the art, selected from the group of the char-forming and fire blanketing flame retardants, such as ammonium phosphate or dipentaerythritol, the barrier-forming flame retardants, such as water glass, borates and ammonium polyphosphates, the solid inorganic flame retardants and the insulating layer-forming flame retardants or intumescent agents. Furthermore, inorganic or organic phosphorus compounds, halogenated organic compounds, such chlorinated paraffins, or halogenated organic phosphorous compounds can be used as additional flame retardants. Solid inorganic flame retardants are, for example, inorganic compounds, such as hydrous aluminum oxides, borates, e.g., zinc borates, ammonium phosphates, antimony oxides, aluminum hydroxides, preferably aluminum trihydroxide, and magnesium hydroxide. Aluminum hydroxide and magnesium hydroxide are also known as water splitting flame retardants. The solid inorganic flame retardant aluminum trihydroxide is preferred. These flame retardants can be present in the cork layer either alone or as a mixture containing at least two of these flame retardants (from the same or different groups listed above).

In a preferred embodiment, at least one phosphorus-containing flame retardant is used in addition to perlite as the preferred silicon-containing inorganic compound. The phosphorus-containing flame retardant includes at least one phosphorous-containing compound. Examples of phosphorous-containing compounds are preferably selected from the group of phosphate, phosphite, phosphonate or its salts, organically substituted phosphonate or its salts, phosphinate or its salts, organically substituted phosphinate or its salts, and mixtures thereof. Examples of organically substituted phosphonates are cyclic or acyclic esters of organic phosphoric acids, such as diesters, e.g., dimethylpropane phosphonate. Particularly preferred is the use of at least one phosphinate in addition to perlite. The phosphorous-containing flame retardant can be used, for example, in an amount of up to approximately 20% by weight, preferably in an amount ranging from 0.1 to 10% by weight, more preferably ranging from 0.1 to 6% by weight relative to the weight of the cork layer.

In a further preferred embodiment, the cork-based floor covering contains water glass as a flame retardant in addition to perlite, preferably heat-treated perlite. Water glass is preferably used in an amount of up to approximately 15% by weight relative to the weight of the cork layer.

To manufacture such a cork floor covering according to the invention, cork granulate with a defined grain size distribution and residual moisture (preferably 1.5-3.0%) is usually mixed with melamine formaldehyde resin as a binder and the above-described flame retardant used according to the invention and a conventional cross-linking catalyst. The binder component is typically 10-30% by weight, since a portion of the binder is bound by the flame retardant additives. This mixture is placed into thick-walled steel molds (e.g., 700 mm wide, 1000 mm long and 800 mm high) and is compressed (preferably 10-200 t). Cross-linking occurs, e.g., at 110-135° C. within 8 to 22 hours. The blocks produced from the cork granulate (having a residual height of, for example, 100-300 mm depending on the degree of compression/pressure) are then cut/skived into individual plates by means of a band shearing machine. The plates are, e.g., 1 to 10 mm thick. To obtain a smooth surface with sharp contours, the plates are usually ground and calibrated with the aid of a belt sander. The topside is preferably ground in 3 to 6 grinding passes, initially with a coarse grit and finally with a fine grit (for example 1=40 grit, 2=80 grit, 3=120 grit, 4=180 grit, 5=220 grit, 6=360 grit) The underside is ground in only 1 or 2 grinding passes, e.g., with 24 and 40 grit. The plates can subsequently be surface protected, e.g., by a clear PVC foil (60 or 80 K value), a varnish (PPG or Lott) or a wax (e.g., Solid Floer Wax by Loba, Ditzingen, Germany). Tile-shaped plates are then punched out of the coated plates and the edges are trimmed as necessary using a cutter. Cork plates made in this fashion reach a critical radiation strength greater than 8 kW/m² in accordance with EN ISO 9239-1 and a flame propagation of less than 150 mm within 20 seconds, which corresponds to a B_{fl} classification in accordance with DIN EN 13501-1:1999.

### DETAILED DESCRIPTION OF THE PREFERRED EMBODIMENTS

The present invention and additional advantages resulting therefrom will now be explained in greater detail with reference to the embodiments described in the examples.

### EXAMPLES

Linoleum Floor Covering

All the components for the linoleum mass listed in Table 1 are first mixed in a suitable mixing unit to form a matrix (mass) that is as homogenous as possible. The mass thus obtained is processed into sheets in a roll mill and fed to a grater or granulator. The mass particles thus obtained are then fed to a calender and are pressed onto jute as a backing material under pressure and at a temperature of typically 10° C. to 150° C.

Table 1 lists a recipe according to the invention by way of example. The values indicated are percentages by weight relative to the weight of the total mixture (linoleum layer). The individual components of the recipe shown in Table 1 must be selected to obtain a value of 100 percent by weight for the linoleum layer of each specific recipe.

TABLE 1

| Formula | (% by weight) |
|---|---|
| Linoleum cement | 30-55 |
| Cork flour | 0-25 |
| Wood flour | 5-45 |
| Chalk | 0-60 |
| Titanium dioxide | 1-15 |
| Colored pigments | 0-5 |
| Kieselguhr | 0-8 |
| Zinc oxide | 0-5 |
| Aluminum trihydroxide | 0-60 |
| (Heat-treated) perlite | 0.01-30 |
| Flame retardant | 0-30 |

TABLE 2

| Composition | Standard | 312 | 313 | 314 |
|---|---|---|---|---|
| Linoleum cement, wood | 100 | 91 | 82 | 73 |
| flour, chalk, titanium oxide, | | | | |
| zinc oxide, pigments % | | | | |
| (Heat-treated) perlite % | | 9 | 18 | 27 |

TABLE 3

| | | | Critical | |
|---|---|---|---|---|
| | | Burning | Radiation | Smoke |
| | New | Distance | Intensity | Density |
| Composition | Standard | [cm] | [kW/m²] | [% × min] |
| Standard | >8.0 kW/m² | 31 | 7.30 | 145 |
| 312 | >8.0 kW/m² | 22 | 9.23 | 25 |
| 313 | >8.0 kW/m² | 17 | 10.16 | 59 |
| 314 | >8.0 kW/m² | 9 | 11.00 | 123 |

Heat-treated perlite used here: grain size 40 μm, bulk density (kg/m³) 70±15%, chemical composition SiO₂ 60-75%, Al₂O₃ 12-16%, Na₂O 5-10%, K₂O 2-5%, CaO 0-2%, MgO 0-1%, Fe₂O₃ 0-1%, bound H₂O 1-2%, theoretical density 2.0-2.2 g/cm³, color white, pH 6-8.5, temperature resistant up to 800° C., melting point approximately 1400° C., non-flammable, organic components less than 0.1% by weight.

The recipe listed in Table 1, the concrete compositions 312, 313 and 314 shown in Table 2 and the linoleum floor coverings produced therefrom have dramatically improved flame retardant properties because of the heat-treated perlite used according to the invention as compared to a conventional linoleum floor covering without perlite (“Standard” in Tables 2 and 3) with otherwise substantially equivalent properties, as illustrated by the values shown in Table. 3.

1. Linoleum-based floor covering, comprising at least one linoleum layer, which contains at least one silicon-containing inorganic compound as a flame retardant in an amount of up to 40% by weight relative to the weight of the linoleum layer.

2. Floor covering as claimed in claim 1, wherein the silicon-containing inorganic compound is perlite.

3. Floor covering as claimed in claim 2, wherein the perlite is a heat-treated perlite.

4. Floor covering as claimed in claim 3, wherein the perlite has been heat-treated at a temperature of approximately 1000° C. or above.

5. Floor covering as claimed in any one of the preceding claims, wherein the linoleum layer furthermore comprises a flame retardant selected from the group of char-forming and fire-blanketing flame retardants, barrier-forming flame retardants, intumescent agents, solid inorganic flame retardants or mixtures containing at least two of these additional flame retardants.

6. Floor covering as claimed in claim 5, wherein the additional flame retardant comprises at least one phosphorous-containing flame retardant.

7. Floor covering as claimed in claim 6, wherein the phosphorous-containing flame retardant is selected from the group of phosphate, phosphite, phosphonate or its salts, organically substituted phosphonate or its salts, phosphinate or its salts, organically substituted phosphinate or its salts, and mixtures thereof.

8. Floor covering as claimed in claim 6, wherein the phosphorous-containing flame retardant comprises at least a phosphinate or its salt, an organically substituted phosphinate or its salt, or a mixture thereof.

9. Method for producing a linoleum-based floor covering, comprising at least one linoleum layer, which contains at least one silicon-containing inorganic compound as a flame retardant in an amount of up to 40% by weight relative to the weight of the linoleum layer, wherein the linoleum mass, which contains at least one flame retardant, is processed into a floor covering by means of calenders or roll mills.

10. Method as claimed in claim 9, wherein the silicon-containing inorganic compound is perlite.

11. Cork-based floor covering, comprising at least one silicon-containing inorganic compound as a flame retardant in an amount of up to 40% by weight relative to the weight of the cork layer.

12. Floor covering as claimed in claim 11, wherein the silicon-containing inorganic compound is perlite.

13. Use of a silicon-containing inorganic compound as a flame retardant in linoleum or cork-based floor coverings.

14. Use as claimed in claim 13, wherein the silicon-containing inorganic compound is perlite.

15. Floor covering as claimed in claim 7, wherein the phosphorous-containing flame retardant comprises at least a phosphinate or its salt, an organically substituted phosphinate or its salt, or a mixture thereof.
